(19) United States
(12) Patent Application Publication
(10) Pub. No.: US 2014/0173957 A1
(43) Pub. Date: Jun. 26, 2014

(54) LABLE CLIP FOR DIVIDERS IN INDUSTRIAL BINS

(71) Applicants: Travis Shamp, Akron, OH (US); Christopher Clark, Parma, OH (US); Laura Manson, Medina, OH (US); Jeffery Boll, Tallmadge, OH (US); Jerry Sciarini, Painesville, OH (US)

(72) Inventors: Travis Shamp, Akron, OH (US); Christopher Clark, Parma, OH (US); Laura Manson, Medina, OH (US); Jeffery Boll, Tallmadge, OH (US); Jerry Sciarini, Painesville, OH (US)

(21) Appl. No.: 14/043,999

(22) Filed: Oct. 2, 2013

Related U.S. Application Data
(60) Provisional application No. 61/708,742, filed on Oct. 2, 2012.

(51) Int. Cl. G09F 3/16

(52) U.S. Cl. CPC G09F 3/16
USPC 40/666

(57) ABSTRACT

The present invention provides a label clip for use with a bin divider, having a first major face and a second label bearing face. Typically, the first major face and the second label bearing face are angled from one another by an angle of approximately 0-60° and preferably by about 20°. The faces are connected to a divider of a bin system by an extension leg and a retaining leg and preferably an insertion leg. One or more reinforcing sections may link the extension leg and label face. The clip may also optionally include one or more gripping sections protruding from the extension leg toward the major face.

### CLAIM OF PRIORITY

This Application is a Continuation-in-Part of Provisional Application 61708742, entitled “LABLE CLIP FOR DIVIDERS IN INDUSTRIAL BINS” filed Oct. 2, 2012 all parts of the Provisional filing are hereby incorporated by reference.

### BACKGROUND

A large installed base of bin systems is in use in industrial assembly. Typically, the bins are mounted to a rack system or placed on a shelf or work surface and are accessible from the front or top. The bin systems often include dividers to separate the contents into different sections. Because the dividers are universal, they do not include a tab or vertically extending section to which a label may be applied. The bin systems are difficult to customize for labeling a number of different sections and providing easily visible labeling for different parts.

### SUMMARY

In accordance with embodiments of the present invention, a label clip for use with a bin divider is provided having a first major face and a second label bearing face. Typically, the first major face and the second label bearing face are angled from one another by an angle of approximately 0-60° and preferably by about 20°. The faces are connected to a divider of a bin system by an extension leg and a retaining leg and preferably an insertion leg. One or more reinforcing sections may link the extension leg and label face. The clip may also optionally include one or more gripping sections protruding from the extension leg toward the major face.

### BRIEF DESCRIPTION OF THE DRAWINGS

A more complete appreciation of the invention and the many embodiments thereof will be readily obtained as the same becomes better understood by reference to the following detailed description when considered in connection with the accompanying drawings, wherein:

FIG. 1 illustrates an isometric view of the label clip of the present invention in use with a bin system and dividers;

FIG. 2 illustrates an isometric rear view of the label clip of the present invention.

FIG. 3 illustrates a front plan view of a label clip of the present invention.

FIG. 4 illustrates a rear plan view of a label clip of the present invention.

FIG. 5A illustrates a side plan view of a label clip of the present invention.

FIG. 5B illustrates a side plan view of a label clip of the present invention installed on a thin walled divider.

FIG. 5C illustrates a side plan view of a label clip of the present invention installed on a thick I-Beam type divider.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

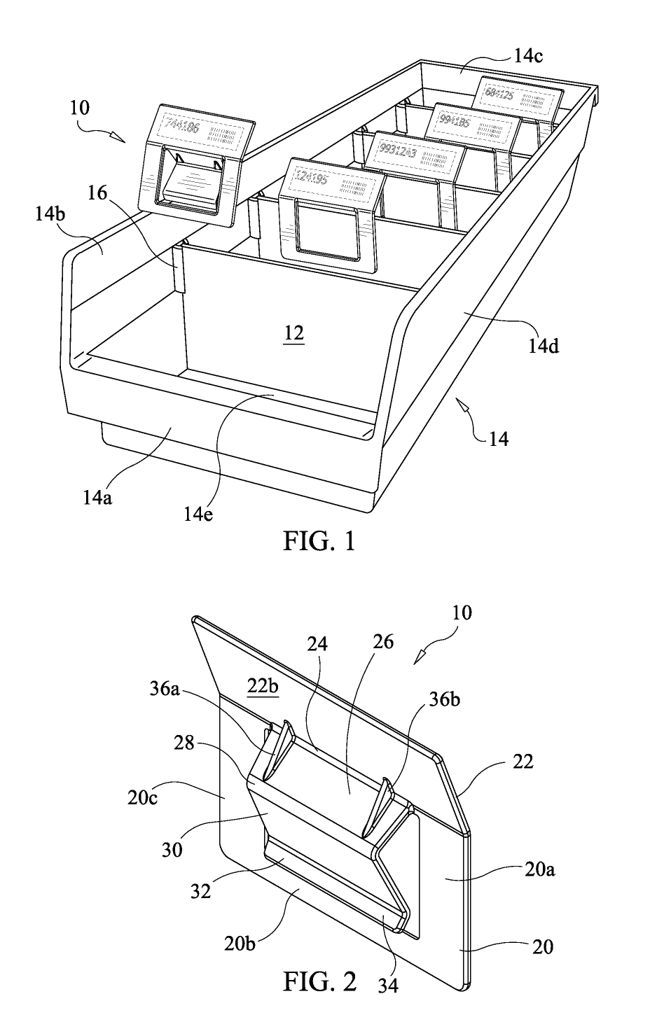

A bin 14 is shown in FIG. 1 providing an integrated, lightweight, and durable base unit. Bin 14 includes front wall 14a, sidewalls 14b, 14d rear wall 14c, and floor 14e, which define the interior of bin 14. Bin 14 includes a number of dividers 12 positioned in the interior that provide subsections of bin 14 for storing a number of small parts. Typically, dividers 12 are held in divider slots 16 on opposite sides 14b, 14d of bin 14. As shown, the bin includes a label clip 10 upon which a label is typically affixed and a clip section attached to the major face. The label clip may be placed upon any number of dividers 12 within bin 14. The label clip 10 improves visibility of the label and improves the efficiency of assembly personnel that access the contents of bin 14.

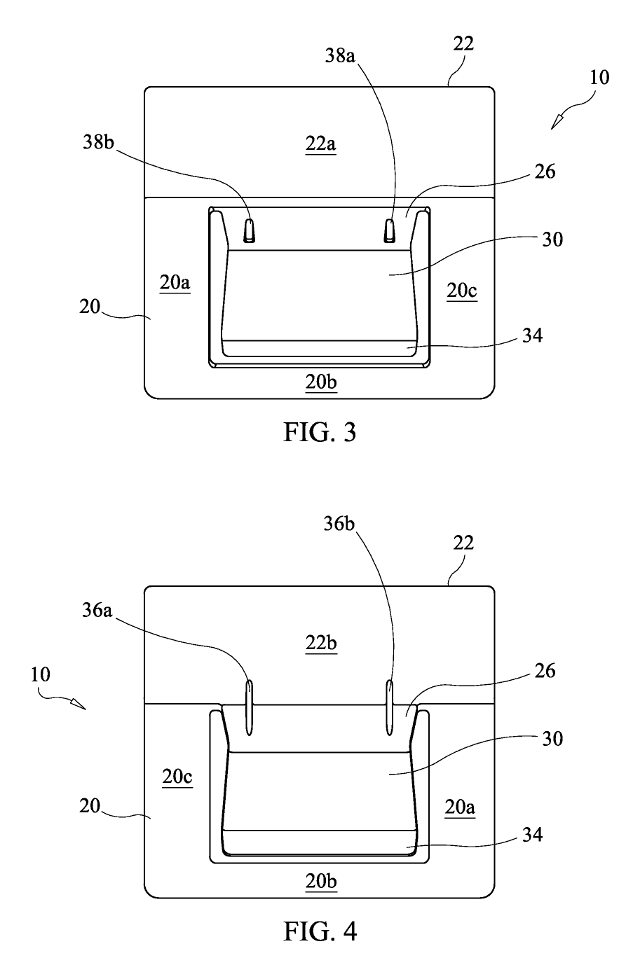

A label clip 10 is shown in FIG. 2 having a label section 22 with a front label face 22a (shown in FIG. 3) and a rear face 22b. The label face 22a may be inclined from the clip section 20 by an angle of up to about 45° to allow for improved readability from the front or top. While 20° is generally the preferred angle, any suitable angle may be used. The label section 22 is generally unitarily formed with a clip section 20. The clip section 20 includes a frame formed of descending beams 20a, 20c, and lower beam 20b. A cantilevered leg descends from label section 20 to retain the label clip 10 to the dividers 12, as shown in FIG. 1. The cantilevered leg generally includes first angled joint 24, extension leg 26, second angled joint 28, retaining leg 30, third angled joint 32 and deflector 34. The cantilevered leg may be provided with one or more support ribs 36a, 36b that extend from rear face 22b to extension leg 26. Deflector 34 is angled from retaining leg 30 to provide a wider entrance for the upper surface of a bin divider 12 (as seen in FIG. 1).

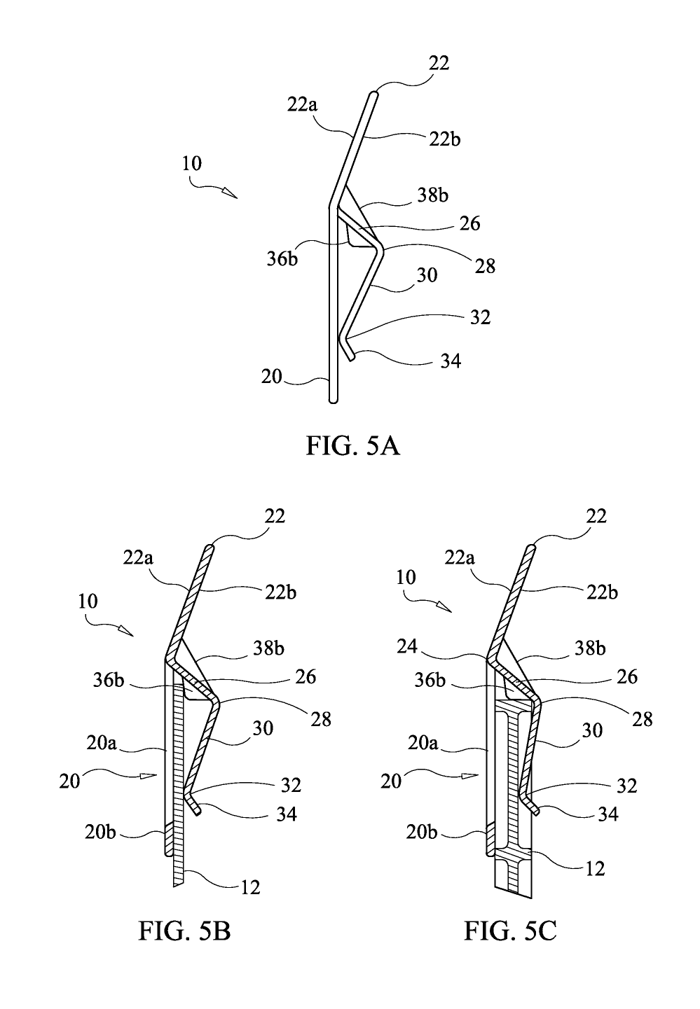

The front of label clip 10 of the present invention is also shown in FIG. 3. Label section 22 with a front label face 22a may be inclined from the clip section 20 by an angle of up to about 45° to allow for improved readability from the front or top. While 20° is generally the preferred angle, any suitable angle may be used. Clip section 20 is formed of descending beams 20a, 20c, and lower beam 20b. Descending beams 20a, 20c and lower beam 20b with label section 22 form a frame that contacts the front face of the divider 12 (as shown in FIG. 1). A cantilevered leg descends from label section 20 into the frame formed by descending beams 20a, 20c and lower beam 20b to retain the label clip 10 to the dividers 12 (as shown in FIG. 1). Extension leg 26, retaining leg 26, and deflector 34 form the cantilevered leg. Extension leg 26 may be provided with one or more stanchions 38a, 38b that extend downwardly from extension leg 26 to contact the top of an I-Beam type divider 12 (as shown in FIG. 5C). Label section 22 joins clip section 22 at a radiused angle of up to about 45° and preferably about 20°. Label clip 10 is unitarily formed with the cantilevered leg extending from the back of label face 22b. Extension leg 26 separates the distal portion of the cantilevered leg from the rear face of frame 20a, 20b, and 20c.

The rear of label clip 10 of the present invention is also shown in FIG. 4. Label section 22 having a preferred thickness of 0.075″ [1.91 mm] with a front label face 22b may be inclined from the clip section 20 by an angle of up to about 45° to allow for improved readability from the front or top. While 20° is generally the preferred angle, any suitable angle between about 60° and 10° may be used. The angle may be 0° if a vertical label is desired. Clip section 20 is formed of descending beams 20a, 20c, and lower beam 20b. Descending beams 20a, 20c and lower beam 20b with label section 22 form a frame that contacts the front face of the divider 12 (as shown in FIG. 1). A cantilevered leg descends from label section 20 into the frame formed by descending beams 20a, 20c and lower beam 20b to retain the label clip 10 to the dividers 12 (as shown in FIG. 1). Extension leg 26, retaining leg 26, and deflector 34 form the cantilevered leg. Extension leg 26 may be provided with one or more reinforcing ribs 36a, 36b that extend downwardly from rear face 22b to extension leg 26 to reinforce first angled joint 24 (as shown in FIG. 2).

The side of label clip 10 of the present invention is also shown in FIG. 5A. The clip 10 has a preferred overall height of 2.780″ [70.61 mm] with label section 22 being 1.030″ [26.16 mm] and clip section 20 being 1.750″ [44.45 mm]. Label section 22 with a front label face 22a may be inclined from the clip section 20 by an angle of up to about 45° to allow for improved readability from the front or top. While 20° is generally the preferred angle, any suitable angle may be used. Label section 22 and clip section 20 have a preferred width of 3.120″ [79.25 mm]. Clip section is formed of descending beams 20a, 20c, and lower beam 20b. Descending beams 20a, 20c and lower beam 20b with label section 22 form a frame that contacts the front face of the divider 2 (as shown in FIG. 1). A cantilevered leg descends from label section 20 into the frame formed by descending beams 20a, 20c and lower beam 20b to retain the label clip 10 to the dividers 12 (as shown in FIG. 1). Extension leg 26 is angled about 40° from clip section 20 to a depth of about 0.486″ [12.35] from clip section 20. Retaining leg 30 extends back toward clip 20 to a distance of about 0.015″ [0.38 mm]. Deflector 34 angles away from clip 20 by an angle of about 30°. The stations 36a, 36b extend downwardly from the face of extension leg 26 with a gap of about 0.080″ [2.03 mm] from clip section 20 to allow planar divider 12 to fit between station 36a, 36b and the rear face of clip 20.

The side of label clip 10 installed on a narrow bin divider 12 is shown in FIG. 5B. Label section 22 includes front label face 22a and rear face 22b are integrally formed with clip section 20. Clip section 20 includes descending beams 20a, 20c, and lower beam 20b. Descending beams 20a, 20c, and lower beam 20b with label section 22 form a frame that contacts the front face of the divider 12. A cantilevered leg descends from label section 20 into the frame formed by descending beams 20a, 20c, and lower beam 20b to retain the label clip 10 to the divider 12. First angled joint 24, extension leg 26, second angled joint 28, retaining leg 30, third angled joint 32, and deflector 34 form the cantilevered leg. Reinforcing ribs 38a, 38b extend between rear face 22b and extension leg 26. Stanchions 38a, 38b extend downwardly from extension leg 26 to contact the face of a planar divider 12.

The side of label clip 10 installed on a narrow bin divider 12 is shown in FIG. 5C. Label section 22 includes front label face 22a and rear face 20b that are integrally formed with clip section 20. Clip section 20 includes descending beams 20a, 20c, and lower beam 20b. Descending beams 20a, 20c, and lower beam 20b with label section 22 form a frame that contacts the front face of the divider 12. A cantilevered leg descends from label section 20 into the frame formed by descending beams 20a, 20c, and lower beam 20b to retain the label clip 10 to the divider 12. First angled joint 24, extension leg 26, second angled joint 28, retaining leg 30, third angled joint 32, and deflector 34 form the cantilevered leg. Reinforcing ribs 38a, 38b extend between rear face 22b and extension leg 26. Stanchions 36a, 36b extend downwardly from extension leg 26 to contact the top of an I-Beam type divider 12. The I-beam top of the bin divider 12 fits between second angled joint 28 is pressed against the rear face of clip section 20. The angled joint 32 of the cantilevered leg contacts bin divider 12 to removably retain the label clip 20 on bin divider 12.

While the label clip 20 may be formed of any suitable material and by any method, typically the clips are formed of injection molded plastic or metal. Generally the label clip will be formed of by injection molding from ABS, acetyl polymers, nylon, or polystyrene (HIPS), polypropylene or polyethylene is or any other suitable polymer. The label clip may also be made from stamped and formed metal. The label clip may be formed in any size of general configuration in accordance with the disclosure herein.

What is claimed is:

1. A label clip for use with a bin divider, comprising:
a label bearing section having a front and a rear;
a clip section; and
a cantilevered leg joined to the label bearing section and having an extension leg, having a proximal end adjacent the label bearing section that is angled away from the clip section and a retaining leg linked to the extension leg that angles toward the clip section.

2. The label clip of claim 1, wherein the cantilevered leg further comprises:
a deflector having a proximal end that is joined to the distal end of the retaining leg.

3. The label clip of claim 1, wherein the label bearing section and the clip section are angled from one another by an angle of approximately 10-45°.

4. The label clip of claim 1, wherein the label bearing section and the clip section are angled from one another by an angle of approximately 0-60°.

5. The label clip of claim 1, wherein the label bearing section and the clip section are angled from one another by an angle of approximately 20°.

6. The label clip of claim 1, further comprising:
one or more reinforcing ribs linking the extension leg and label bearing section.

7. The label clip of claim 1, further comprising:
one or more stanchions protruding from the extension leg toward the clip section.

8. The label clip of claim 1, wherein the clip is formed by injection molding.

9. The label clip of claim 1, wherein the clip is formed from a polymer selected from the group of ABS, acetyl polymers, nylon, or polystyrene (HIPS), polypropylene and polyethylene.

10. A label clip for use with a bin divider, comprising:
a label bearing section having a front and a rear;
a clip section;
a cantilevered leg joined to the label bearing section and having an extension leg, having a proximal end adjacent the label bearing section that is angled away from the clip section and a retaining leg linked to the extension leg that angles toward the clip section;
a deflector having a proximal end that is joined to the distal end of the retaining leg;
wherein the label bearing section and the clip section are angled from one another by an angle of approximately 10-45°.

11. The label clip of claim 10, wherein the label bearing section and the clip section are angled from one another by an angle of approximately 20°.

12. The label clip of claim 10, further comprising:
one or more reinforcing ribs linking the extension leg and label bearing section.

13. The label clip of claim 10, further comprising:
one or more stanchions protruding from the extension leg toward the clip section.

14. The label clip of claim 10, wherein the clip is formed by injection molding.

15. The label clip of claim 10, wherein the clip is formed from a polymer selected from the group of ABS, acetyl polymers, nylon, or polystyrene (HIPS), polypropylene and polyethylene.

16. A label clip for use with a bin divider, comprising:
a label bearing section having a front and a rear;
a clip section;
a cantilevered leg joined to the label bearing section and having an extension leg, having a proximal end adjacent the label bearing section that is angled away from the clip section and a retaining leg linked to the extension leg that angles toward the clip section;
a deflector having a proximal end that is joined to the distal end of the retaining leg;
one or more reinforcing ribs linking the extension leg and label bearing section;
one or more stanchions protruding from the extension leg toward the clip section; and
wherein the label bearing section and the clip section are angled from one another by an angle of approximately 20°.

17. The label clip of claim 16, wherein the clip is formed by injection molding.

18. The label clip of claim 16, wherein the clip is formed from a polymer selected from the group of ABS, acetyl polymers, nylon, or polystyrene (HIPS), polypropylene and polyethylene.
